(19) United States
(12) Patent Application Publication
(10) Pub. No.: US 2011/0139725 A1
(43) Pub. Date: Jun. 16, 2011

(54) APPARATUS FOR TREATING POOL WATER, AND IN PARTICULAR SWIMMING POOL WATER, WITH A HALOGEN DERIVATIVE, AND AN ASSOCIATED METHOD OF USING THE APPARATUS

(75) Inventor: Zbigniew STADNICKI, City Le Cayre (FR)

(73) Assignee: PACIFIC INDUSTRIE, Boulazac (FR)

(21) Appl. No.: 12/907,480

(22) Filed: Oct. 19, 2010

(30) Foreign Application Priority Data
Oct. 20, 2009 (FR) 09 05040

(51) Int. Cl. E04H 4/14; C02F 1/68

(52) U.S. Cl. 210/744; 210/96.1

(57) ABSTRACT

The present invention relates to treatment apparatus for treating pool water, and in particular swimming pool water, with a halogen derivative, the treatment apparatus comprising production means for producing said halogen derivative by electrolysis from an aqueous solution containing a halogen salt, and measurement means for measuring the concentration of halogen derivative in the pool, wherein the treatment apparatus further comprises:

regulation means for regulating the production of the halogen derivative and making it possible to vary the speed and the duration of production of the halogen derivative;

processor means for processing data obtained by the measurement means and making it possible to cause the regulation means to follow a regulation profile for regulating the speeds and durations of production of the halogen derivative as a function of the concentration of said halogen derivative in the pool.

The present invention relates to apparatus for treating pool water, and in particular swimming pool water, with a halogen derivative, and it also relates to an associated method of using the apparatus.

The invention is advantageously applicable to the field of treating residential swimming pool water. However, although it is intended particularly for such a use, the present application is also applicable to other types of pool, such as public swimming pools, or indeed, more generally, to pools that have their water treated by electrolytic means.

### BACKGROUND OF THE INVENTION

In order to avoid proliferation of bacteria, bathing water is treated with disinfectants that are generally based on halogen derivatives, and mainly on chlorine derivatives such as sodium hypochlorite.

Such chlorine derivatives can be fabricated on site, and, to that end, electrolyzers or “chlorinators” are known that make it possible to produce the necessary quantity of disinfectant from an aqueous solution of a halide salt that is generally sodium halide.

The method of treatment by electrolysis is simple. It consists in applying a relatively high voltage across the terminals of an electrolyzer placed in the water intake or recirculating duct of the pool, so as to produce a large quantity of disinfectant necessary for the treatment.

That method of treatment is reliable and advantageous, in particular, compared with treatment in which the disinfection is achieved by chlorine tablets, since that method makes it possible to reduce problems related to transporting, storing, and preserving the disinfectants.

Unfortunately, that method suffers from drawbacks, among which is the fact that the electrolyzer, which operates in all-or-nothing mode, consumes a great deal of energy and, in view of its stop-start use, has a short life.

In addition, the disinfectant content in the water of the pool, as equipped with one or more electrolyzers, is not optimum because the quantity of disinfectants produced in the pool is generally too high in order to avoid the risk of falling below a minimum threshold for disinfectant concentration.

In that type of method, no fine adjustment takes place to accommodate the fact that the disinfectant concentration can vary rapidly as a function of many different parameters, since, in that type of method, operation of the electrolyzer does not make it possible to adapt to such rapid variation. In other words, in pragmatic manner, the electrolyzer is programmed on installation to produce a constant daily quantity of disinfectant, resulting in such electrolyzers not being fully satisfactory as regards the swimming pool water quality that they procure, and also having high maintenance and operating costs.

### OBJECT OF THE INVENTION

An object of the invention is to propose an improvement to known electrolysis treatment apparatus and methods that makes it possible to mitigate the above-mentioned drawbacks.

### SUMMARY OF THE INVENTION

To this end, the invention provides treatment apparatus for treating pool water, and in particular swimming pool water, with a halogen derivative, the treatment apparatus comprising production means for producing said halogen derivative by electrolysis from an aqueous solution containing a halogen salt, and measurement means for measuring the concentration of halogen derivative in the pool, wherein the treatment apparatus further comprises:
regulation means for regulating the production of the halogen derivative and making it possible to vary the speed and the duration of production of the halogen derivative;
processor means for processing data obtained by the measurement means and making it possible to cause the regulation means to follow a regulation profile for regulating the speeds and durations of production of the halogen derivative as a function of the concentration of said halogen derivative in the pool.

The invention also provides an associated method that comprises: a measurement step of measuring the concentration of the halogen derivative; a processing step making it possible to implement a regulation profile for regulating the speeds and the durations of production of the halogen derivative; and a production step of producing the halogen derivative following the implemented profile.

### BRIEF DESCRIPTION OF THE DRAWINGS

The present invention can be better understood on reading the following detailed description of an embodiment with reference to the accompanying drawings, which are given by way of non-limiting example, and in which:

FIG. 1 is a flow chart showing an implementation of the various steps of the method of the invention; and

FIG. 2 is a diagram showing an embodiment of the treatment apparatus of the invention.

### DETAILED DESCRIPTION OF THE INVENTION

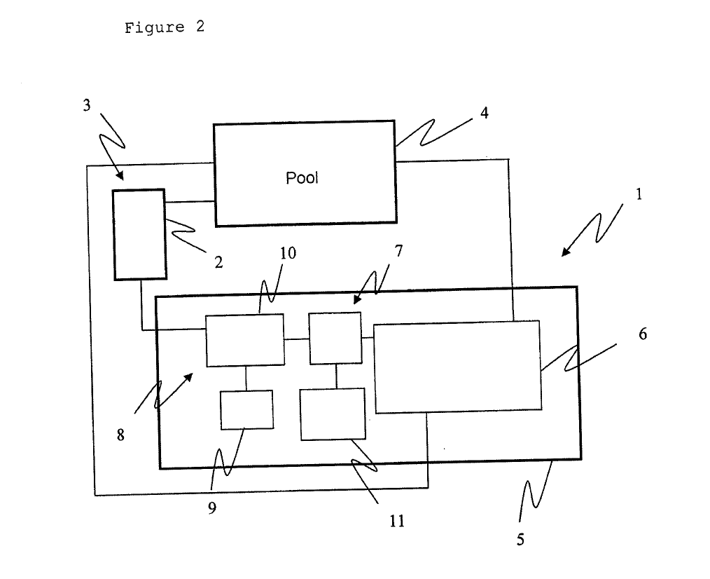

With reference mainly to FIG. 2, it is possible to see treatment apparatus 1. In the example shown, this treatment apparatus 1 is made up of two portions, namely a first portion 2 including measurement means 3 for measuring the chlorine concentration of a pool 4.

The apparatus 1 also has a second portion 5 including production means 6 for producing said halogen derivative by electrolysis, from an aqueous solution, as well as regulation means 7 for regulating the production of the halogen derivative, and data-processing means 8.

Incorporating the production means 6, the regulation means 7, and the processor means 8 in the same housing is advantageous, in particular in terms of manufacturing costs. However, in other embodiments, the production means 6 may be separate from the regulation means 7 and from the processor means 8.

By way of example, in a situation when the treatment of the water of a pool requires a plurality of electrolyzers, the apparatus 1 advantageously includes, in a housing, regulation means 7 and processor means 8 enabling the electrolyzers to be controlled centrally and remotely.

The measurement means for measuring the concentration are chosen to deliver reliable and automatic measurement of the chlorine concentration. To this end, the measurement means of the embodiment shown are of the colorimetric type. This type of measurement makes it possible to obtain an accurate measurement of the chlorine concentration by causing the water for analysis to react with a reagent, and by measuring the transparency of the mixture using an optical analyzer.

In accordance with the invention, the regulation means 7 make it possible to vary the speed and the duration of production of the halogen derivative. To this end, in a preferred embodiment, the regulation means 7 include means for varying the voltage applied across the electrodes of the electrolyzer.

The production of chlorine derivative is directly dependent on the current transmitted between the electrodes of the electrolyzer, and therefore, a variation in the current makes it possible to vary the speed of production of the chlorine. These variation means are advantageously implemented by a digital potentiometer.

As a function of the characteristics of the electrolyzer, provision is made for the regulation means 7 to make it possible for the current at the terminals of the electrolyzer to vary from 0 amps (A) to 20 A. The variation in the current also advantageously takes place with a step-size of 0.5 A. The regulation means 7 are connected to the power supply 11 of the apparatus 1.

In accordance with the invention, the processor means 8 make it possible to cause the regulation means 7 to follow a regulation profile for regulating the speeds and durations of production of the derivative as a function of the concentration of the halogen derivative in the pool.

The use of a regulation profile for regulating the chlorine production is particularly advantageous, firstly at the treatment apparatus 1 where, by following a profile, it is possible to cause the electrolyzer to operate successively at low, medium, and high speeds, and not, as in the state of the art, constantly on an all-or-nothing basis.

This modulation thus makes it possible to limit the energy consumption of the apparatus, and also spares the electrolyzer itself, the parts of the electrolyzer then being less likely to wear prematurely.

In addition, the use of a profile makes it possible to diffuse the chlorine derivatives more evenly throughout the pool, thereby avoiding peaks of chlorine or, conversely, a risk of too low a chlorine content or of an absence of production of chlorine for a period during which the quantity of chlorine derivatives decreases rapidly, e.g. when the temperature of the pool increases rapidly, or when the number of occupants in the pool increases rapidly.

Regulation by profile therefore makes it possible to adapt finely to the quantity of disinfectant necessary, and therefore also makes it possible to reduce the quantity of aqueous solution of sodium chloride that is consumed.

In order to make it possible to determine the appropriate profile, the processor means 8 use the data transmitted by the measurement means 3, and compare the measurements with regulation profiles stored in a memory 9 by a processor 10.

Said memory 9 makes it possible to store at least one regulation profile for various different concentrations of the halogen derivative, making it possible to select a profile that is adapted to the data obtained by the measurement means 3.

In accordance with an advantageous characteristic, the processor means 8 make it possible to analyze and store in the memory 9 at least one additional parameter relative to the water in the pool. Various parameters may be recorded, such as the variation in the concentration of halogen derivative and/or the temperature of the pool and/or the volume of water in the pool, making it possible to constitute a large variety of regulation profiles, enabling the regulation means 7 to be controlled appropriately.

Taking the example of the temperature of the pool as an additional parameter, and for any given concentration of chlorine, the memory 9 contains various different regulation profiles corresponding to different pool temperatures, making it possible to produce a quantity of chlorine at optimum speed and for an optimum duration. To this end, the processor means 8 are also connected to temperature-measuring means.

As indicated above, various different additional parameters may be used for improving, over time, the accuracy of the treatment in terms of chlorine content in the pool. For certain parameters, such as the quantity of water in the pool, it is possible for the data to be input directly into the processor means 8 by an operator by means of a keypad connected to or incorporated in the processor means 8.

Advantageously, the processor means 8 record, in the memory 9, the measured data making it possible to constitute new regulation profiles.

Various profiles may be considered as a function mainly of the difference between the concentration of chlorine as measured, and the concentration of chlorine as required in the pool. However, the preferred regulation profiles are regulation profiles that have a stage during which the speed of production increases stepwise, followed by a stage in which the duration of production increases.

The present invention also relates to a method of treating pool water, in particular swimming pool water, with halogen derivatives, for using the treatment apparatus 1 as mentioned above.

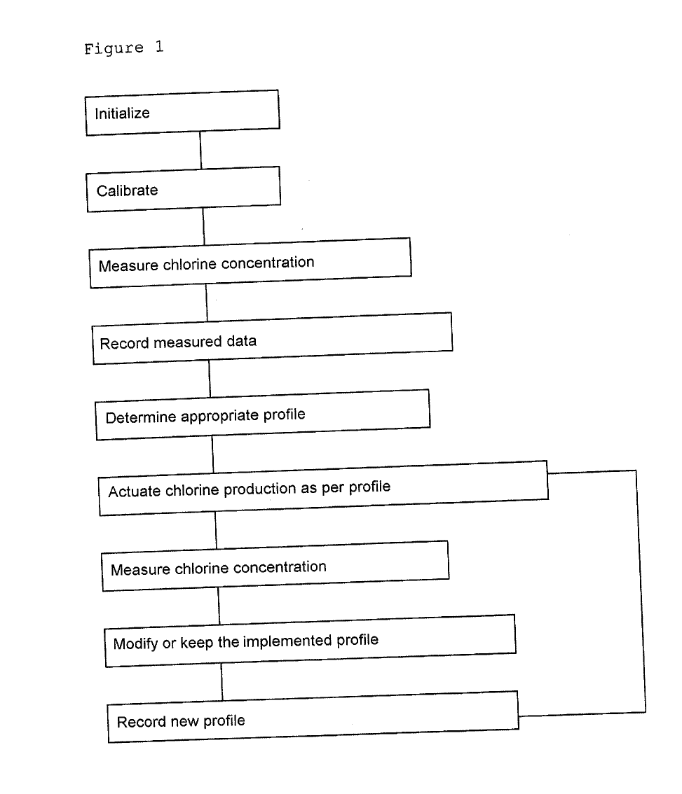

FIG. 1 is a flow chart showing the various steps in the method that comprises: a measurement step of measuring the halogen derivative concentration, a processing step making it possible to implement a profile for speeds and durations of production of the halogen derivative, and a production step of producing the halogen derivative following the implemented profile.

Advantageously, at least an additional measurement step and a processing step are performed. In this way, the apparatus 1 adapts to variations in the chlorine content in the pool, making it possible to keep or to modify the profile for producing the halogen derivative. The additional measurement is preferably performed a waiting time after the latest injection of chlorine into the pool, so that the chlorine concentration has become stabilized.

The method may further comprise an initialization step and a calibration step that can be performed in the factory or in situ. The treatment method may further comprise a step of regulating the pH of the pool.

Other characteristics may be devised for the invention without going beyond the ambit of the invention as defined by the claims below.

Thus, by way of example, although the treatment apparatus is described above for treatment with chlorine derivatives, the invention also applies to other types of halogen derivative, in particular bromine derivatives. Similarly, the aqueous solution of salt is not limited to sodium chloride, and other salts, such as, for example calcium salts that are known to the person skilled in the art, may be considered.

In the embodiment, the concentration measurements are obtained by colorimetric measurement means. However, the present Application is not limited to this type measurement, and the concentration measurement may be achieved by using other automatable measurement means.

1. Treatment apparatus for treating pool water, and in particular swimming pool water, with a halogen derivative, the treatment apparatus comprising production means for producing said halogen derivative by electrolysis from an aqueous solution containing a halogen salt, and measurement means for measuring the concentration of halogen derivative in the pool, wherein the treatment apparatus further comprises:
regulation means for regulating the production of the halogen derivative and making it possible to vary the speed and the duration of production of the halogen derivative;
processor means for processing data obtained by the measurement means and making it possible to cause the regulation means to follow a regulation profile for regulating the speeds and durations of production of the halogen derivative as a function of the concentration of said halogen derivative in the pool.

2. Treatment apparatus according to claim 1, wherein the regulation means comprise means for varying the voltage applied across the terminals of an electrolyzer equipping the production means.

3. Treatment apparatus according to claim 2, wherein the regulation means are arranged to make it possible to vary the current at the terminals of the electrolyzer from 0 A to 20 A.

4. Treatment apparatus according to claim 1, wherein the processor means have a memory making it possible to store at least one regulation profile for various different concentrations of the halogen derivative, making it possible to select a profile adapted to the data obtained by the measurement means.

5. Treatment apparatus according to claim 4, wherein the processor means make it possible to analyze and to store in the memory at least one additional parameter relating to the water in the pool.

6. Treatment apparatus according to claim 5, wherein said at least one additional parameter is the variation in the concentration of the halogen derivative and/or the temperature of the pool and/or the volume of water in the pool and/or the pH of the pool, making it possible to constitute a large variety of regulation profiles so as to guarantee that the regulation means are controlled appropriately.

7. Treatment apparatus according to claim 4, wherein the processor means are arranged to record, in a memory, the measured data making it possible to constitute new regulation profiles.

8. Treatment apparatus according to claim 4, wherein the regulation profiles include a stage in which the speed of production increases stepwise, followed by a stage in which the duration of production increases.

9. A method of treating pool water, in particular swimming pool water, with halogen derivatives, using treatment apparatus according to claim 1, said method comprising:
a measurement step of measuring the concentration of the halogen derivative;
a processing step making it possible to implement a regulation profile for regulating the speeds and the durations of production of the halogen derivative; and
a production step of producing the halogen derivative following the implemented profile.

10. A method of treatment according to claim 9, further comprising at least an additional measurement step and a processing step making it possible to keep or to modify the production profile for producing the halogen derivative.
